(19) United States
(12) Patent Application Publication
(10) Pub. No.: US 2025/0267196 A1
(43) Pub. Date: Aug. 21, 2025

(54) INTERACTIVE ONLINE ENTERTAINMENT SYSTEM AND METHOD

(71) Applicant: HYTTO PTE. LTD, Singapore (SG)

(72) Inventors: Dan LIU, Guangzhou (CN); Jilin QIU, Guangzhou (CN)

(73) Assignee: HYTTO PTE. LTD, Singapore (SG)

(21) Appl. No.: 19/202,272

(22) Filed: May 8, 2025

Related U.S. Application Data
(63) Continuation-in-part of application No. 17/748,294, filed on May 19, 2022, now abandoned.
(63) Continuation-in-part of application No. 18/806,047, filed on Aug. 15, 2024, now Pat. No. 12,318,340.
Application No. 18/806,047 is a continuation of application No. 18/351,390, filed on Jul. 12, 2023.
Application No. 18/351,390 is a continuation of application No. 17/714,278, filed on Apr. 6, 2022, now Pat. No. 11,737,948.

(51) Int. Cl. A61H 19/00; G06Q 50/00; H04L 9/40; H04L 67/125

(52) U.S. Cl. CPC A61H 19/00; H04L 67/125; G06Q 50/01; H04L 63/0236; H04L 2209/56; H04L 2209/80

(57) ABSTRACT

Embodiments of the present application pertain to a method, a system and an application program providing online interactive entertainment for adults. The system includes a computing device which runs the application program. The computing device broadcasts an audio and video live stream session to terminal devices via a communication network. The computing device receives one or more tokens from a user of a terminal device during the broadcast. The tokens are rewards to a host of the live stream session. If an amount of tokens received from the terminal device is greater than or equal to a reward parameter, the computing device establishes a control connection between the computing device and the terminal device. The computing device instructs, through the control connection, an electronic device to perform one or more actions. The electronic device is an adult toy connected with the terminal device.

### CROSS-REFERENCE TO RELATED APPLICATIONS

This application is a Continuation-In-Part of U.S. application Ser. No. 17/748,294, filed May 19, 2022. This application is also a Continuation-In-Part of U.S. application Ser. No. 18/806,047, filed Aug. 15, 2024, which is a Continuation of U.S. application Ser. No. 18/351,390, filed Jul. 12, 2023, which is a Continuation of U.S. application Ser. No. 17/714,278, filed Apr. 6, 2022, and issued as U.S. Pat. No. 11,737,948 on Aug. 29, 2023. The entire disclosure of each of the above-identified applications are incorporated herein by reference.

### TECHNICAL FIELD

The present application generally relates to communication systems. Particularly, embodiments of the present application are directed to hardware and software technologies for online interactive entertainment with adult contents.

### BACKGROUND

With development of Internet technologies, people are able to connect and interact instantly via social networking programs such as online chatting and live streaming. These programs allow two or more individuals, usually located at different locations, to communicate in real-time. In recent years, live streaming is gaining more and more popularity. Live streaming technology enables a person to watch, create and share videos in real time. A live streaming session is typically hosted by a presenter, an organizer, a performer or the like (collectively referred to as a host hereinafter) in a live streaming studio or similar environment, and viewers of the live streaming session may interact with the host via a form of live conversation such as chatrooms. The host can also receive financial rewards from the viewers. For example, the viewers can tip the host in virtual coins, which can be converted into real currency.

Some live streaming applications can provide entertainment for adults (individuals whose ages are above certain limit as defined by applicable laws and regulations) wherever as permitted by law. In this regard, existing adult live streaming generally functions similarly to conventional live streaming, with exception of explicit contents. One current challenge for adult live streaming is to provide the right kinds of interactivity and real world features, so that a large number and wide range of adult users would be attracted by the more enjoyable experiences.

### SUMMARY

The following provides a brief summary of the disclosure in order to provide a basic understanding of some aspects of the present application. This summary is not an extensive overview of the present application. Its purpose is to disclose some concepts of the present application in a simplified manner as a prelude to the more detailed description that is presented later.

In a first aspect, a method for providing online interactive entertainment for adults is provided by embodiments of the present application. A computing device broadcasts an audio and video live stream to a plurality of terminal devices via a communication network. The computing device receives an indication of one or more tokens from a user of a terminal device during the broadcast of the live stream. If an amount of tokens received from the terminal device is greater than or equal to a reward parameter, the computing device establishes a control connection between the computing device and the terminal device. The computing device instructs, through the control connection, an electronic device to perform one or more actions. The electronic device is an adult toy connected with the terminal device.

In a second aspect, an online entertainment system for adults is provided by embodiments of the present application. The system includes a computing device, a terminal device connected with the computing device via a communication network, and an electronic device connected with the terminal device. The electronic device is an adult toy controlled by a user of the terminal device. The computing device includes a processor, a memory for storing an application program, and a transceiver for communicating with the terminal device. By executing the application program, the computing device is enabled to control the electronic device remotely. The computing device broadcasts an audio and video live stream to a plurality of terminal devices via the communication network. The computing device receives an indication of one or more tokens from a user of the terminal device during the broadcast of the live stream. If an amount of tokens received from the terminal device is greater than or equal to a reward parameter, the computing device establishes a control connection between the computing device and the terminal device. The computing device instructs, through the control connection, the electronic device to perform one or more actions.

In a third aspect, an application program is provided for execution by a processor of a computing device, wherein the application program include instructions for broadcasting an audio and video live stream, wherein the live stream is receivable by a plurality of terminal devices via a communication network; receiving an indication of one or more tokens from a user of a terminal device during the broadcast of the live stream; if an amount of tokens received from the terminal device is greater than or equal to a reward parameter, establishing a control connection between the computing device and the terminal device; and instructing, through the control connection, an electronic device to perform one or more actions, wherein the electronic device is an adult toy connected with the terminal device.

The application program further includes instructions for displaying a control panel on a screen of the computing device. The control panel includes status information of the computing device and the plurality of terminal devices, and control keys for receiving control inputs. The status information includes one or more of waiting status of the computing device when the computing device is waiting for a tip, and controlling status of one or more terminal devices when establishing control connections. The control keys include operative control buttons corresponding to different levels of action by the electronic device, different control patterns, and different time, durations.

In the light of the foregoing, these and other objects are accomplished in accordance of the principles of the present application, wherein the novelty of the present application will become apparent from the following detailed description and appended claims.

### BRIEF DESCRIPTION OF DRAWINGS

The above and other objects and advantages of the present application will be apparent upon consideration of the following detailed description, taken in conjunction with the accompanying drawings, in which like reference characters refer to like parts throughout, and in which:

FIG. 1 is a schematic illustration of an application scenario of the interactive online entertainment system according to embodiments of the application;

FIG. 2 is a block diagram of the interactive online entertainment system according to embodiments of the application;

FIG. 3 is a flowchart of an interactive live streaming session according to embodiments of the present application;

FIG. 4 is a signal diagram of controlling the viewer's toy in a live streaming session according to the flowchart as shown in FIG. 3;

FIG. 5 is a signal diagram between entities of the interactive online entertainment system according to an embodiment of the present application;

FIG. 6 is an exemplary flowchart of operations from a host's side; and

FIG. 7 is an exemplary flowchart of operations from a viewer's side.

The disclosure will next be described in connection with certain exemplary embodiments. However, it should be clear to those skilled in the art that various modifications, additions, and subtractions can be made without departing from the spirit or scope of the appending claims.

### DETAILED DESCRIPTION

The present application pertains to a communication system and method that enable controlling of electronic devices over distances. In particular, the present application relates to actuating adult toys over distances in a live streaming session. For purposes of clarity, and not by way of limitation, illustrative views of the disclosed system and method are described with references to the above-identified figures. Various modifications obvious to one skilled in the art are deemed to be within the spirit and scope of the present application.

As used in this application, the terms “component,” “module,” “system,” “interface,” or the like are generally intended to refer to a computer-related entity, either hardware or a combination of hardware and software. For example, a component can be, but is not limited to being, a process running on a processor, an object, and/or a computer. By way of illustration, both an application running on a controller and the controller can be a component. One or more components can reside within a process and/or thread of execution and a component can be localized on one computer and/or distributed between two or more computers. As another example, an interface can include input/output (I/O) components as well as associated processor, application, and/or application programming interface (API) components.

It is to be appreciated that determinations or inferences referenced throughout the application can be practiced through the use of artificial intelligence techniques. In this regard, some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

Discussions herein utilizing terms such as, for example, “processing,” “computing,” “calculating,” “determining,” “establishing,” “identifying,” “analyzing,” “checking,” or the like, may refer to operations(s) and/or process(es) of a computer, a computing platform, a computing system, or other electronic computing device, that manipulate and/or transfer data represented as physical (e.g., electronic) quantities within the computer's registers and/or memories into other data similarly represented as physical quantities within the computer's registers and/or memories or other information storage medium that may store instructions to perform operations and/or processes.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion.

Additionally, the articles “a” and “an” as used in this application and the appended claims should generally be construed to mean “one or more” or “at least one” unless specified otherwise or clear from context to be directed to a singular form. Similarly, the terms “plurality” and “a plurality” as used herein includes, for example, “multiple” or “two or more.” For example, “a plurality of items” includes two or more items.

As used herein, the terms “user,” “users,” “end user,” “end users,” “audience,” “client,” “clients,” “customer,” and “customers” are interchangeable unless the context clearly suggests otherwise. Similarly, as used herein, the terms “host,” “hosts,” “performer,” “performers,” are used interchangeably unless the context clearly suggests otherwise. The terms “web browser extension,” “browser extension,” and “website” are used interchangeably unless the context clearly suggests otherwise. Furthermore, the foregoing terms “web browser extension,” “browser extension,” and “website” may be collectively referred to as “application,” “software,” or “software application.”

Some embodiments may be used in conjunction with various devices and systems. For example, a computing device or computer may be a server, a gateway device or a terminal device, such as a personal computer (PC), a desktop computer, a mobile computer, a laptop computer, a tablet computer, a server computer, a handheld device, a personal digital assistant (PDA), a wireless communication device, a smart cellular phone, a non-portable device, a wireless access point (AP), a wired or wireless router, a wired or wireless modem.

For another example, a communication network may be a wired or wireless network, a local area network (LAN), a wireless LAN (WLAN), a metropolitan area network (MAN), a wireless MAN (WMAN), a wide area network (WAN), a wireless WAN (WWAN), a personal area network (PAN), a wireless PAN (WPAN), or networks operating in accordance with existing and/or future versions and/or derivatives of the long term evolution (LTE) network, or a fifth generation (5G) New Radio (NR) communication network.

Besides the computing devices as mentioned above by examples, an electronic device may be a device that is designed to perform certain functions. The electronic device may incorporate a global positioning system (GPS) receiver or transceiver or chip, a radio frequency identification (RFID) element or chip, a multiple input multiple output (MIMO) transceiver or device, a single input multiple output (SIMO) transceiver or device, or a multiple input single output (MISO) transceiver or device. The electronic device may have one or more internal antennas and/or external antennas, or the like. Particularly, certain electronic devices whose main purpose is to provide sexual stimulation, entertainment and/or therapy for adult users are collectively referred to herein as “adult toys” or “toys.” Various kinds of adult toys are well known in the art and are not described in details herein.

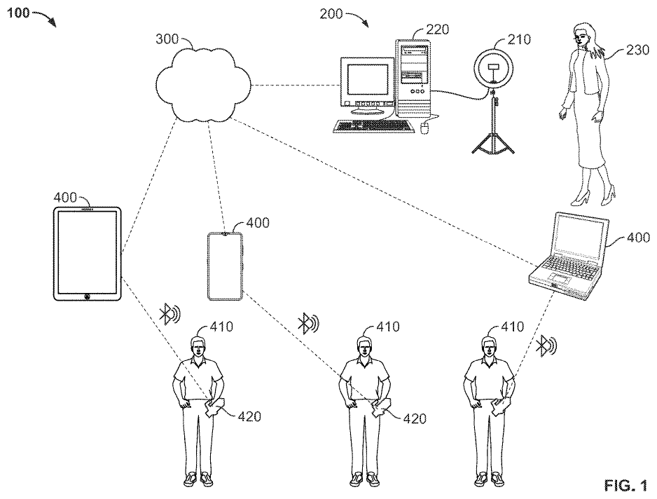

FIG. 1 is a schematic illustration of an application scenario of an interactive online entertainment system 100 in accordance with some embodiments of the present application. The system 100 includes equipment such as a live streaming studio 200. The live streaming studio 200 may include some or all of various studio equipment 210 (such as props, lighting equipment, speakers, microphones, cameras, audio/video players, etc.) capable of generating a stream of audio and video signals, and a computing device 220 having application programs for broadcasting the stream in real time or near real time (i.e. live streaming) through a communication network 300 (e.g. Internet, satellite, cable, etc.). Usually but not necessarily, a live streaming service is provided by a software platform or a website (such as Facebook Live, Bilibili, Youtube Live, etc. or a proprietary program provided by the inventor of the present application). A user of such a platform can set up a live streaming session and be a host 230. The host 230 usually announces the session through the platform. For example, the platform associates a quick response (QR) code or a Uniform Resource Locator (URL) with the session, and publish the QR code or the URL on a webpage. Other users of the platform can view the session on their computing devices by scanning the QR code or directing their web browsers to the URL. During a live streaming session hosted by the host 230, a viewer 410 may use a computing device or a terminal device (collectively referred to as a user device 400, which is connected to the communication network 300) to view the performance or presentation of the host 230 on the user device 400. According to the embodiments of the present application, during the live streaming session, the viewers are enabled to interact with the host 230 via a two-way communication such as live chatrooms or on-screen messages. A message sent by the viewer 410 to the host 230 may be displayed on a screen of the host's computing device 220. The message may or may not be visible to other viewers of the session, depending on privacy settings of the session. Similarly, a message sent by the host 230 to the viewer 410 may be displayed on the user device 400.

The user device 400 according to the embodiments of the present application also provides communication connectivity to an electronic device 420 via a WiFi network or a short-range radio link such as Bluetooth™M. The electronic device 420 may be an adult toy as defined above, and the viewer 410 may operate or control the toy 420 by hands or via the user device 400.

As will be discussed in the details below, the interactive inline entertainment system 100 as provided by the embodiments of the present application enables the host 230 to control the viewer's toy 420 during a live streaming session, so as to provide entertainment to the viewer 410.

It is to be understood that the existing live streaming technology enables a larger number of viewers to view a live streaming session, and to interact with the host 230 simultaneously, and the viewer 410 is a representation of such viewers.

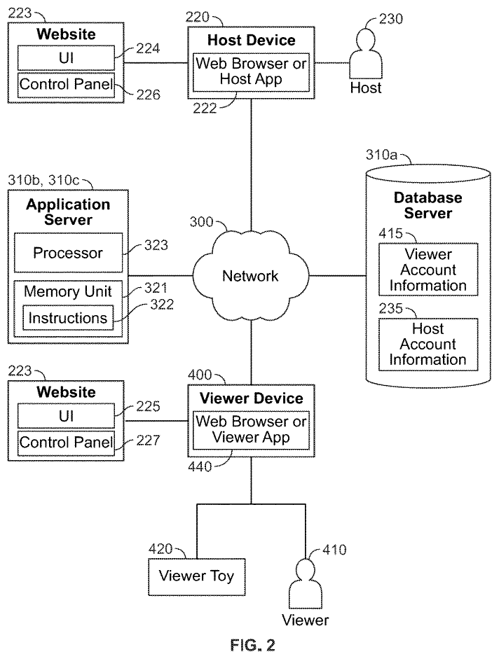

FIG. 2 is a technical block diagram of the interactive online entertainment system 100 in accordance with embodiments of the present application.

In the system 100, for providing a live stream, the host 230 uses studio equipment 210 and a computing device 220. The computing device 220 includes a variety of hardware components, software modules and input/output (I/O) interfaces. For example, the computing device 220 may include one or more processors, controllers, memory units, storage units, display units, input circuits, output circuits, wired or wireless communication transceivers, operating systems, application programs, or the like. The studio equipment 210 may be connected to one or more of the I/O interfaces of the computing device 220, to allow audio and video signals be inputted to the computing device 220. When broadcasting a live streaming session, the host 230 launches an application program 222 installed in the computer equipment 220, from which the host 230 can access a website 223 of the live streaming platform to set up the live streaming session (e.g. date, time, duration, restriction, etc.). The a session link URL or a QR code is generated for the live stream session.

A viewer 410 launches an application program 402 on the user device 400. The application program 402 connects the user device 400 to the website 223. The session link URL or the QR code of the live stream session is displayed on a screen of the user device 400. The viewer 410 can view the live streaming on the user device 400 by clicking the session link URL or scanning the QR code.

It should be understood that the website 223 may simultaneously provide URLs or QR codes for multiple live streaming sessions hosted by different hosts, and viewers may select a host from multiple hosts to enter into a live stream session of the host via the website 223.

In addition to viewing the live streaming, the host 230 may engage in an online chat with the viewer 410 via a host's user interface (UI) 224 of the application program 222 and the viewer 410 can chat with the host 230 via a viewer's UI 404 of the application program 402. The UI 404 allows the viewer 410 to enter a message to the host 230 and/or sand a tip (reward) in an amount of virtual tokens to the host 230. It should be understood that, during the live streaming, the host 230 may simultaneously engage in live conversations with multiple viewers and accept tips from multiple viewers.

The user device 400 may be one of a wide range of devices such as a personal computer (PC), a desktop computer, a mobile computer, a laptop computer, a tablet computer, a handheld device, a personal digital assistant (PDA), a smart cellular phone, or the like. There is no limitation on what user device may be used to view the live streaming.

The live streaming platform allows the host 230 to set up a host account 235 and the viewer 410 to set up a viewer account 415, respectively. In creating or updating the viewer account 415, the viewer 410 can create/update his or her username and password and input age (for verifying eligibility) and payment information (such as bank account, credit card number, or online payment account), plus other types of identification information associated with the viewer 410, if necessary. The website 223 verifies the information of the viewer 410 and grants a permission if the viewer 410 is verified as eligible and credible. Similarly, the host 230 can create/update the host account 235 by inputting/updating information such as the host's name, age, gender, location, and the like, and the information is verified.

There may be one or more servers that provide data storage and program execution for the live streaming. In embodiments of the present application, the servers may be connected to host's computing device 220 and the viewer's device 400 directly or via the communication network 300. For example, a database server 310a provides a database which stores information of the viewer account 415 and information of the host account 235. The viewer account 415 and the host account 235 may be updated in real-time with the live streaming. An application server 310b may be configured to handle broadcasting of the live streaming. Another application server 310c may be configured to provide live interaction between the host and the viewers, and to send/receive reward tokens. As an example, the application server 310b may include a memory unit 321 having instructions 322 stored thereon, and a processor 323, wherein the processor 323 is configured to execute the instructions 322.

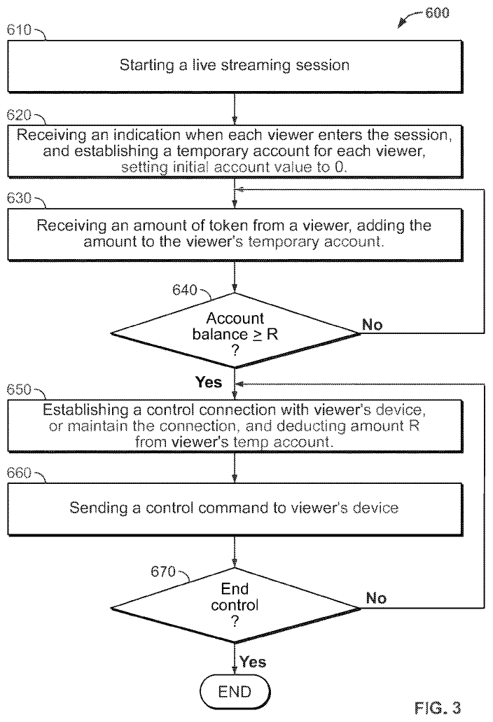

FIG. 3 is a flowchart of a live streaming session 600 according to an embodiment of the present application.

At block 610, the live streaming session is started by a host 230 and is broadcast to multiple viewers by a live streaming website 223 via a communication network 300. During or before the broadcast, a URL or a QR code associated with the session is displayed on viewers' devices, enabling the viewers to enter the session and view the host 230. Preferably, each viewer is pre-registered with the website 223, so an account of the viewer is properly set up as described above. Similarly, the host 230 also sets up a host account 235, enabling the host 230 to receive rewards or tips from the viewers.

The website 223 may simultaneously provide information of multiple live streaming sessions hosted by different hosts, and viewers may select a host from multiple hosts to enter into a live stream session of the host via the website 223. Depending on settings, a live streaming session can be a private (i.e., one-on-one) session, a group session (i.e., limited number of viewers and one host), or a public session (i.e., unlimited number of viewers).

During the live streaming, the website 223 provides the host's UI 224 and the viewer's UI 225 that allow the viewer 410 and the host 230 to send and receive messages in a textual and/or audio format, so as to have a live conversation with each other (e.g., in an online chatroom). The messages may or may not be visible to or playable by other viewers of the session, depending on privacy settings of the session.

At block 620, during the live streaming session, the website 223 receives an indication when each viewer enters the session. For example, a viewer 410 enters the session by directing a browser running on user device 400 to the URL or scanning the QR code associated with the session. The website 223 establishes a temporary account for each viewer. An initial value of the temporary account may be set to zero, or any other value.

At block 630, the website 223 receives an indication that the viewer 410 has sent an amount of virtual coins (aka tokens) as a reward to the host 230. The website 223 adds the amount of tokens to the viewer's temporary account. Meanwhile, an amount of currency corresponding to the amount of token is deducted from the viewer's account 415. The viewer 410 can send tokens multiple times, and the amount of tokens in the temporary account accumulates.

During the live streaming session, the website 223 allows the host 230 to accept tokens from some or all of the viewers as tips or rewards. The tokens can be converted into a real currency and credited to the host's account 235. The host 230 can define and edit reward parameters that are applied during the live streaming session, and display the reward parameters with the live streaming. The website 223 may allow the host 230 to designate specific tip amounts and/or ranges of tip amounts, and define actions correlating to each of the tip amounts and/or ranges. For example, the host 230 may require the tips in increments of five tokens, where each token corresponds to an amount of real currency, such as one dollar.

At block 640, the website 223 determines if the amount of token currently in the viewer's temporary account equals or exceeds a reward parameter R.
a) If the answer is no, the website 223 continues to wait for indication of more reward tokens from the viewer 420.
b) If the answer is yes, at block 650, the website 223 establishes a control connection between the computing device 220 and the user device 400. Meanwhile, an amount of tokens equivalent to the reward parameter R is deducted from viewer's temporary account. The control connection between the computing device 220 and the user device 400 may be established for a pre-determined time duration corresponding to the reward parameter R. If more tokens are received after the deduction, the duration of the control connection may be extended. Alternatively, if the control connection has been established previously, and the viewer's temporary account still has unused tokens or new tokens are added after the control connection is established, the control connection may be extended by applying the remaining tokens.

In some embodiments, the website 223 is configured to, on behalf of the host 230, send a message to the viewer 410 asking if the viewer 410 accepts control of the viewer's toy 420 by the host 230. If the viewer 410 responds with an indication agreeing to the control of the viewer's toy 420, the host 230 gains the control of the viewer's toy 420 either directly (if the toy 420 is Wi-Fi enabled) or via the viewer's user device 400 to which the toy 420 is connected via a short-range radio link such as Bluetooth™.

In some embodiments, establishing the control connection between the computing device and the terminal device may include the website 223 sending a message to the user device 400. The message requests the viewer 410 to indicate whether to grant a permission to control the viewer's toy 420 through the user device 400. The user device 400 sends a reply to the website 223 granting the permission. After receiving the permission, the control connection is established. Establishing the control connection means the computing device 220 is enabled to control the toy 420. The control connection may last for the entire live streaming session, or for a pre-determined time duration which is shorter than the length of the session.

In embodiments of the present application, the actions correlating to each of the tip amounts and/or ranges may include performances of the host 230 (such as singing and/or dancing by the host 230) for a pre-defined time duration, or controlling the tipping viewer's toy 420 remotely (such as over the network 300) to perform a function or functions of the toy 420 for a pre-defined time duration.

At block 660, using the computing device 220, the host 230 sends an instruction to the viewer's toy 420 through the control connection, instructing the toy 420 to perform one or more actions corresponding to the reward parameter.

The actions that may be performed by the toy 420 include, and not limited to, one or more of vibration, rotation, swinging, inhalation, temperature variation, expansion, suction, and contraction. Under the control of the host 230, the viewer's toy 420 performs an action as if the toy 420 is controlled by the viewer 410. Each action by the toy 420 may be further defined by parameters such as time duration, intensity, interval, etc. As configured by the host 230, a certain amount of token correlates to a certain action and certain parameters (such as kind of action, duration, intensity, etc.). For example, the host 230 can set up parameters such that a tip amount between 1 to 10 tokens may cause the viewer's toy 420 to vibrate at a low speed for 10 seconds, and a tip amount between 11 to 20 tokens may cause the viewer's toy 420 to thrust at a high speed for 10 seconds. Alternatively, a tip amount of 30 tokens may cause the viewer's toy 420 to rotate at a high speed for 15 seconds.

If the control connection is set for a limited time duration, at block 670, a decision may be made whether to terminate the control connection when the time duration expires, so the computing device 220 of the host 230 no longer controls the toy 420. A termination may be made if the remaining token amount in the viewer's temporary account is less than the reward parameter, if the viewer 410 terminates the connection from the user device 400, if the viewer 410 exits the live streaming session, or when the live streaming session ends. The connection may be maintained or extended if the viewer's temporary account has unused tokens and the viewer 410 agrees to apply the unused tokens. The length of the extension may be proportional to the number of tokens applied.

At the end of the live streaming session, the host 230 may collect all tokens in all temporary accounts of the viewers, and receive a financial reward that is equivalent or proportional to the amount of all collected tokens.

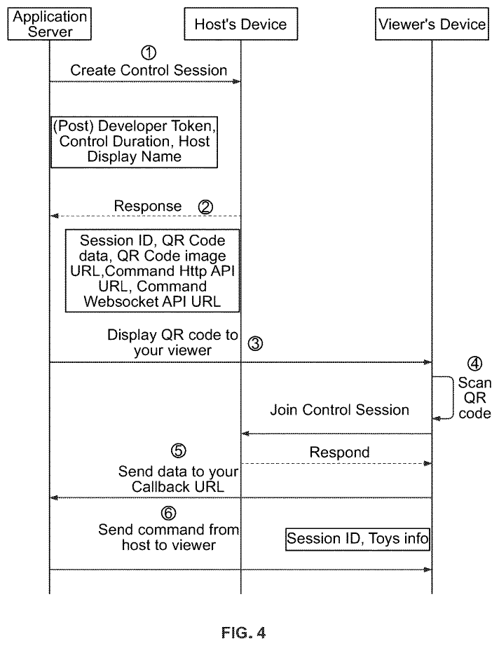

FIG. 4 is a signal diagram of controlling viewer's toy in a live streaming session in accordance with the flowchart of FIG. 3.

Besides website-based live streaming as described above, other types of application programs may also be used. For example, other downloadable and/or a non-downloadable software application (e.g., a plug-in application, an application extension, a mobile application) may be used in lieu of or in addition to the website 223, and operations or functions of these software applications are similar to the website 223, with features designed to implement the present invention.

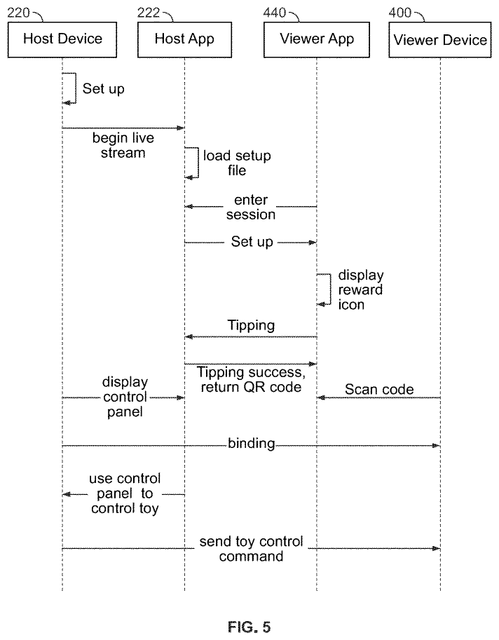

FIG. 5 is a signal diagram of the interactive online entertainment system 100 according to some embodiments of the present application. According to these embodiments, a host 230 has an application program or a plug-in (collectively referred to as host's app 222) installed in the host's computing device 220, and a viewer 410 has an application or a plug-in (collectively referred to as viewer's app 402) installed in the viewer's user device 400. In order to establish a control connection between the host 230 and the viewer 410 (in response to host 230 providing a code and the viewer 410 scanning or entering the code), steps as shown in FIG. 5 are performed.

The host 230 launches the host's app 222, which allows the host 230 to set up various reward parameters for a live streaming session. The host's app 222 starts the live streaming session. By uploading a configuration file, for example, the host 230 is able to configure the settings of the live streaming session, such as privacy setting, time setting, reward parameter setting, etc., and take control of the live streaming session.

A viewer 410 launches the viewer's app 402 on the user device 400 and enters the live streaming session by scanning the code. The live streaming is displayed on the viewer's device 400. By entering the live streaming session, the viewer 410 is able to tip the host 230 and invite the host 230 to take control. “Taking control” means the host is permitted to establish a “controlled by the host” connection with the viewer's toy 420. In some embodiments, the “controlled by the host” connection is established by dialogs between the host's app 222 and the viewer's app 402 via the application server 320 of the interactive online entertainment system 100. The user device 400 “talks” to the toy 420 through a short-range wireless communication link.

The viewer's app 402 is configured to display a reward icon on the user device 400. If the viewer 410 wants to tip the host 230, the viewer 410 mat click the icon. Reward parameters set up by the host 230 may be displayed as a drop-down menu on the user device 400. The viewer 410 can send a tip by selecting an option on the drop-down menu. If the tip is successfully sent, the host's app 222 returns a QR code, and the QR code is displayed on the viewer's screen. The viewer 410 scans the QR code, allowing the host's device 220 to bind with the viewer's device 400. Subsequently, the host's app 222 is enabled to take control of the viewer's toy 420 via the viewer's device 400.

A control panel is displayed on host's device 220. The host's app 222 senses a control command input by the host 230 via the control panel, and sends the control command to the viewer's device 400.

The host's app 222 is configured to scan for tips during live streaming sessions and receive tips from viewers of the session. The host's app 222 can determine whether received tips from a viewer 410 falls within one of the tip parameters or whether the tip is equal to or greater than a specified tip amount defined by the host 230. For example, if one of the tip parameters is 1 to 10 tokens to vibrate the viewer's toy 420 at a low speed for 10 seconds, and the viewer 410 tips 4 tokens, then the tip amount is valid. If, however, one of the tip parameters is 11 to 20 tokens to vibrate the viewer's toy 420 at a high speed for 10 seconds, the tip amount is not enough and the viewer 410 may be prompted to adjust (i.e., increase) the tip amount, in some embodiments. Alternatively, the viewer's toy 420 can still react as long as the tip falls in one of the tip parameters. It is contemplated that the viewer 410 can purchase credits, points, or other types of virtual currency such as tokens that can be credited to his or her account 315 and use the virtual currency to tip the host 230.

If the host's app 222 determines that the received tip is less than the reward parameter, it may be configured to send a notification to the viewer's device 400 alerting the viewer 410 that the tip amount is insufficient and the viewer's toy 420 won't be actuated.

The viewer 410 can enter a tip amount during the live streaming session in more than one manner, for example, by typing in the amount of tip within a conversation thread, or by selecting a tip amount from a drop-down menu. The viewer 410 can tip multiple times during the live streaming session to accumulate the tip amount. Alternatively, one viewer can transfer his/her tip amount to another viewer, i.e. tipping the host on behalf of another viewer.

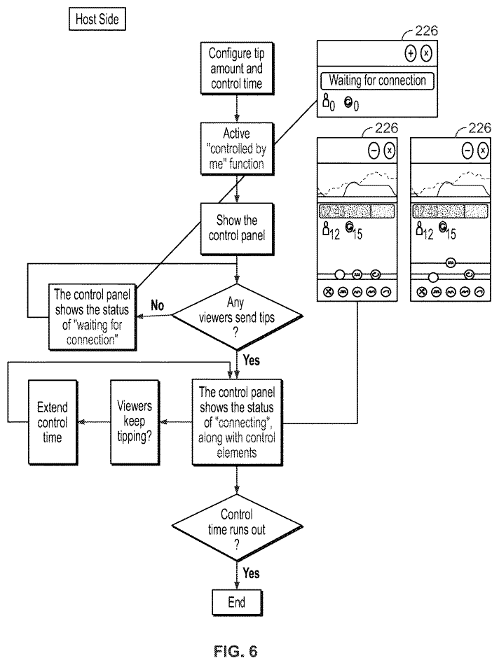

FIG. 6 is an exemplary flowchart of operations from a host's side. The host 230, by using the host's app 222, configures tip amount(s) and a control time length for a live streaming session. Also, in accordance with the above description, the host 230 activates a “controlled by me” function by using the host's app 222. As a result, a control panel is displayed on host's device 220. During the live streaming, the host's app 222 scans the viewers of the session to see if any viewer has send a tip. If no viewer is sending the tip, the control panel displays the status of “waiting for connection.” If a tip is received from a tipping viewer, the control panel shows the status of “connecting”, along with control elements.

After a connection is established with the tipping viewer, the host 230 can select an action from the actions icons displayed in the control panel and send a command to the viewer's toy 420 in a manner as described above. The toy 420 performs the action for a pre-defined controlling period. Controlling time remaining is displayed on the control panel.

During the controlling period, the host's app 222 continues to scan (1) for any tips from other viewers, and establish a control connection for each tipping viewer; (2) for continued tipping from the connected viewers. The control time may be extended if there is more tipping from the connected viewers. When the control time runs out, the control connection ends.

Optionally, when running the host's app 222, a control panel is displayed on a screen of the host's device 220. The control panel includes status information of the host's device 220 and the plurality of terminal devices, and control keys for receiving control inputs from the host 230. The status information may include one or more of waiting status of the computing device 220 when the computing device 220 is waiting for a tip, and controlling status of one or more terminal devices when establishing control connections. The control keys include operative control buttons corresponding to different levels of action by the electronic device 420, different control patterns, and different time durations.

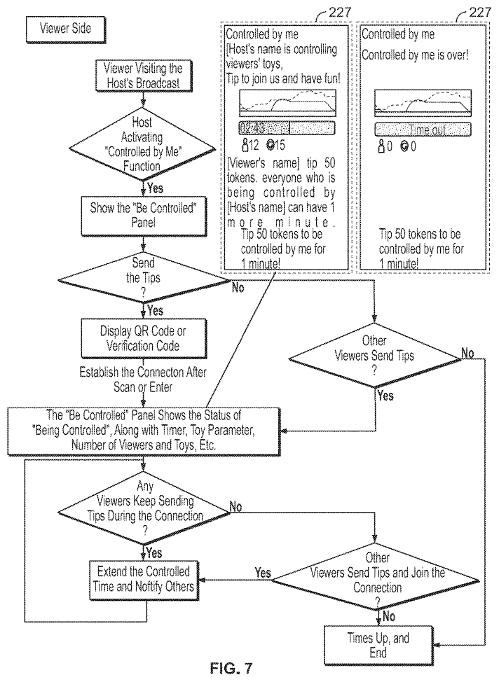

FIG. 7 is an exemplary flowchart of operations from a viewer's side. The viewer 410 launches the viewer's app 402 on a user device 400 to visit the live streaming broadcast of the host 230. The live streaming is displayed on the user device 400. The host's app 402 activates a “controlled by me” function after the viewer 410 grants a permission. A “be controlled” panel is displayed on the user device 400. The viewer 410 can now decide whether to send a tip to the host 230 using the “be controlled” panel. Further, the viewer 420 can refer to information displayed on the user device 400 to determine the amount of tokens to be sent to the host 230.

If the viewer 410 decides to send a tip, after receiving the tip, the host's app 222 causes a QR code or a verification code to be displayed on the user device 400. The viewer 410 gives the permission of being controlled by scanning or entering the code. The “be controlled” panel shows the status of “being controlled”, along with other information, such as a timer, parameters of the toy to be controlled, numbers of viewers currently tipping, number of toys currently active, etc.

If the viewer determines not to send a tip, the “controlled panel” does not show the status of “being controlled”, but number of viewers currently tipping and number of toys currently active may still updated and displayed.

If the viewer 410 is “being controlled”, the user device 400 will receive commands from the host's device 220, and the viewer's toy 420 is actuated by the host 230 via a connection between the user device 400 and the toy 420, such as a Bluetooth™ connection.

In alternative embodiments, the host's control to the viewers' toys can be in a one-to-many manner. If multiples viewers tip the host, and a total amount of tokens from the viewers is greater than or equal to a reward parameter set by the host, all the tipping viewers may have their toys be controlled by the host for a pre-defined time duration. During the controlling period, the host's app scans for more tips from the viewers. If more tips are received form any of the viewers, or if there is new tipping viewers join, the controlling period may be extended for all viewers, and all viewers are notified of the extension. If no more tips is received, the controlling connection ends at the expiration of the controlling period for all the viewers.

In other alternative embodiments, the host's app 222 is configured to set up a time window for collecting tips from viewers. The total amount of tips, or individual amount of tips from each tipping viewer, accumulates in the time window. When time window closes, the host's app 222 determines if the total tip amount, or each individual tip amount, reaches a preset threshold. If the tip amount reaches the threshold, the host's app 222 establishes control connections to the qualified tipping viewers.

In some embodiments, the system for remotely controlling a sexual stimulation device comprises a processor and a memory device storing instructions that, when executed, facilitate a series of technical operations. To establish a local connection between the first user's terminal (a viewer) and their sexual stimulation device, the system leverages an application installed on the first terminal, such as a dedicated mobile app or desktop software. This application employs short-range wireless communication protocols like Bluetooth® (using the Bluetooth Low Energy [BLE] standard) or near-field communication (NFC) to pair with the device. The local connection is secured through authentication mechanisms, such as pairing codes or device-specific keys, to ensure only authorized devices can communicate with the terminal.

When the first user initiates a control link generation request via the application or a browser (e.g., Chrome, Safari), the system's backend processes the request by generating a unique control link. This link is a uniform resource locator (URL) structured to point to a web service hosted on a control server, which instantiates a control interface independent of any social platform. The URL may include a unique identifier (e.g., a hashed string combining the user ID and a timestamp) to ensure uniqueness and prevent unauthorized access. The control interface is implemented as a standalone web application using technologies like HTML5, CSS, and JavaScript, hosted on a domain separate from social platforms to maintain independence.

Upon generating the control link, the system transmits it to the first terminal, which the user can then share as a private message on a social platform (e.g., WhatsApp, Facebook Messenger). The transmission to the second terminal (a host on a live-stream platform) occurs without integrating with the social platform's API, ensuring the control link remains a self-contained URL that the host can access via their browser or a compatible app. When the host clicks the link, the system establishes a real-time connection using protocols like WebSocket (for bidirectional, low-latency communication) or HTTP/2 (for efficient data transfer). This connection is managed by a socket server or a load-balanced server cluster to handle multiple concurrent sessions.

The control interface provided to the second terminal displays a control panel featuring interactive elements such as buttons, sliders, and dropdown menus, designed to receive operational inputs (e.g., selecting vibration intensity, rotation speed, or duration). These inputs are translated into activation commands by the system, which are then relayed from the second terminal to the first terminal through the established real-time connection. The first terminal, in turn, converts these commands into device-specific signals (e.g., Bluetooth GATT commands) and sends them via the local connection to the sexual stimulation device, which executes the corresponding operational mode (e.g., a 30-second high-frequency vibration pattern).

In some embodiments, the system extends the functionality of claim 1 by integrating HTTP and socket-based communication layers. When the second user triggers the control link via a browser (e.g., Firefox) or a dedicated application on their terminal, the system's HTTP server (configured with Nginx or Apache) receives the access request. This server parses the URL to identify the control link and initiates a lookup in a database to retrieve associated control link information, which includes rendered data for the control panel—such as HTML markup, CSS styling, and JavaScript logic for interactivity. The control panel is embedded within a web interface that uses cross-origin resource sharing (CORS) to ensure it loads independently of the social platform, avoiding dependency on the platform's JavaScript SDK or embedded widgets.

To enable real-time interaction, the system establishes a socket connection via a socket server (e.g., Socket.IO or Node.js WebSocket server). This connection creates a persistent channel for transmitting operational input data from the control panel, such as button clicks or slider movements, in real-time. The data is formatted as JSON objects containing metadata like the command type (e.g., “vibrate”), parameters (e.g., intensity: 75%, duration: 60 s), and a timestamp. The socket connection uses binary data transfer for efficiency and employs error-checking mechanisms to ensure no data loss during transmission, allowing the second user's inputs to immediately reflect in the device's operation.

In some embodiments, the system incorporates validation and user consent mechanisms for the control link. Upon receiving an access request from the second terminal, the system first verifies the control link's validity by checking two factors: (1) a timestamp to ensure it has not expired (e.g., links expire after 60 minutes unless extended) and (2) a cryptographic signature generated during link creation to prevent tampering. This verification is performed by a backend service that queries a database storing active control links with their expiration times and hash values. If valid, the system sends a connection request notification to the first terminal, which may appear as a pop-up in the user's app or a push notification on their device. The notification includes the second user's identity identifier (e.g., their username or a hashed user ID) and, if applicable, their permission level (e.g., “Basic” or “Premium” based on past interactions).

Once the first user accepts the request (via a confirm button in the app), the system establishes the real-time socket connection between the terminals. This connection supports bidirectional transmission: the second terminal sends activation commands and control panel interaction data (e.g., which buttons were pressed), while the first terminal sends status updates (e.g., device battery level, current operational mode). The data flow is managed through event-driven listeners in the socket server, ensuring that each command is acknowledged and processed in the order it was received to avoid conflicts.

In some embodiments, the system integrates a token-based reward mechanism to govern control link access. The second user's terminal device sends token indications through the control interface, which are linked to their account in a payment gateway or a virtual currency system (e.g., a blockchain-based token or a platform-specific credit system). The system verifies the total token amount by querying a database that tracks the user's account balance and transaction history. The reward parameter, pre-configured by the first user via a settings page in the control interface, defines the minimum token threshold required to initiate a control connection (e.g., 50 tokens for basic device control, 100 tokens for advanced modes).

When the token amount meets or exceeds the reward parameter, the system triggers the control connection establishment process. This involves notifying the first user's terminal of the pending request, activating the socket connection setup, and associating the allowed operational modes with the token amount (e.g., 50 tokens enable vibration control, while 100 tokens add rotation control). The reward parameter configuration interface in the first user's app includes sliders or input fields to set thresholds and map them to device functions, providing granular control over access privileges.

In some embodiments, the control interface is enhanced with status monitoring and customizable input controls. The status information displayed includes: (1) a “Waiting for Tokens” status when the first user's terminal is idle, showing a countdown timer for link expiration; (2) a “Connecting” status when the second user accesses the link, with a progress bar indicating connection progress; and (3) an “Active Connection” status with real-time metrics like device battery and connection latency. The control keys include physical or virtual buttons (e.g., in a mobile app) that correspond to pre-defined device operations—for example, a “Low Vibration” button linked to a 50 Hz vibration mode, a “Pulse Pattern” button for a rhythmic on-off sequence, and a duration slider allowing the second user to set activation times from 10 to 120 seconds.

These control keys are dynamically associated with the reward parameter; for instance, a button labeled “High Intensity” may only become active if the second user has sent tokens exceeding a higher threshold. The system processes control inputs by converting button clicks or slider movements into command packets that include both the operation type and parameters, which are then encrypted and transmitted via the socket connection to ensure privacy.

In some embodiments, the system includes a financial transaction module accessible via the control interface. The financial transaction interface is integrated with payment processors (e.g., Stripe, PayPal) or cryptocurrency wallets, allowing the second user to transfer funds to the first user. The interface includes a secure payment form where the user selects an amount, chooses a payment method, and confirms the transfer. Upon confirmation, the system initiates a transaction process that: (1) verifies the second user's account balance or payment method validity, (2) deducts the funds from the second user's account, (3) credits the first user's account (after applying any platform fees), and (4) generates a transaction credential—a unique alphanumeric code linked to the transaction, timestamp, and amounts involved.

This credential is displayed on both terminals for record-keeping and can be exported as a PDF or emailed to the users. The system ensures transaction security through SSL/TLS encryption for data transmission and uses blockchain technology for immutable transaction records, if applicable.

In some embodiments, the system supports multiple sexual stimulation devices connected to the first user's terminal. The first user can pair devices via the terminal's application, which scans for available Bluetooth® or Wi-Fi-enabled devices and allows selection from a list. Each device is assigned a unique identifier (e.g., “Device A” for a vibrator, “Device B” for a rotating toy) and displays status information like battery level and connection strength. The control interface presents a device selector—a dropdown menu or a grid of icons—allowing the second user to choose which device to control.

When a target device is selected, the system routes activation commands to the corresponding local connection channel (e.g., a separate Bluetooth GATT service for each device). This enables simultaneous control of multiple devices (e.g., triggering vibration on one device and rotation on another) by packaging commands into a multi-device payload that the first terminal parses and distributes to each device's communication protocol.

In some embodiments, the system implements a robust control link validation process. When the second user accesses the control link, the system checks its validity using a combination of a unique link ID (stored in a database with an expiration timestamp) and a digital signature generated during link creation. The signature is created by hashing the link ID, user IDs, and a secret key using SHA-256, ensuring the link cannot be altered without detection. If the link is valid (i.e., not expired and unmodified), the system retrieves the second user's identity information from a user database, which may include their profile picture, username, and any pre-approved permissions (e.g., “Trusted User” status).

The connection request notification sent to the first terminal includes this information, allowing the user to make an informed decision. Upon acceptance, the system updates the connection status in both terminals' interfaces, enabling real-time control, and logs the connection event for auditing purposes, including timestamps and user IP addresses.

In some embodiments, the system includes a control link time management feature. When generating a control link, the first user specifies a valid time (e.g., 30 minutes, 1 hour, or a custom duration) via a time picker in the app. This time is stored in the database alongside the link ID and is enforced by a background service that checks for expired links every minute. When the valid time expires, the system automatically: (1) terminates the WebSocket or socket connection between terminals, (2) sends a disconnection message to both users, (3) closes the local Bluetooth® or Wi-Fi connection to the sexual stimulation device, and (4) marks the control link as invalid in the database, preventing further access.

The first user can also manually terminate the link at any time via a “Stop Sharing” button in their app, which triggers immediate disconnection and invalidation, overriding the remaining valid time. This manual termination is confirmed by a pop-up dialog to prevent accidental clicks and is logged as a security event.

In some embodiments, the system establishes a bidirectional communication channel alongside the control link connection. This channel supports text, audio, and video transmission using protocols like WebRTC (for peer-to-peer media streaming) and WebSocket (for text messages). The communication module is integrated into the control interface as a separate section, such as a chat window alongside the control panel or a video feed toggle button. For text communication, users type messages into a input field, which are transmitted as JSON objects via the socket connection and displayed in a scrollable message history.

For audio/video, the system uses WebRTC to create a direct peer-to-peer connection (or via a media server for relaying in complex networks), enabling real-time streaming with low latency. The communication data is encrypted using DTLS/SRTP to protect privacy, and the system includes controls for muting audio, turning off video, or blocking the other user if needed. This enhances interactivity, allowing the first user and second user to communicate while the device is being controlled, fostering a more immersive experience.

The instant application has been shown and described in what is considered to be the most practical and preferred embodiments. It is recognized, however, that departures may be made within the scope of the application and that obvious modifications will occur to a person skilled in the art. With respect to the above description then, it is to be realized that the optimum dimensional relationships for the parts of the application, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present application.

Therefore, the foregoing is considered as illustrative only of the principles of the application. Further, since numerous modifications and changes will readily occur to those skilled in the art, it is not desired to limit the application to the exact construction and operation shown and described, and accordingly, all suitable modifications and equivalents may be resorted to, falling within the scope of the application.

What is claimed is:

1. An interactive online entertainment system, comprising:
a processor;
a memory device having stored thereon a set of instructions;
wherein, the set of instructions, when operating on the at least one processor, cause the system to:
establish a local connection between a first terminal of a first user and a sexual stimulation device of the first user through an application installed on the first terminal of the first user, wherein the first user is a viewer;
receive a control link generation request from a first terminal of a first user, the request being transmitted via the application or a browser installed on the first terminal of the first user;
generate a control link in response to the request, the control link comprising a uniform resource locator configured to instantiate a control interface independent of a social platform;
transmit the control link to the first terminal;
transmit the control link from the first terminal of the first user to a second terminal of a second user when the first user posts the control link to the second user as a private message on a social platform, wherein the second user is a host of a live-stream platform;
establish a real-time connection between the first terminal of the first user and a second terminal of the second user when the second user access the control link from the second terminal;
provide to the second terminal in response to access of the control link, the control interface configured to display a control panel independent of the social platform, wherein the control panel is adapted to receive operational input from the second user;
receive from the second terminal, an activation command generated based on the operational input received by the control panel;
relay the activation command from the second terminal to the first terminal;
enable the first terminal to transmit the activation command to the sexual stimulation device via the established local connection, thereby activating the sexual stimulation device to perform an operational mode corresponding to the activation command.

2. The system of claim 1, further causing the system to:
receive, via an HTTP server, an access request from the second terminal when the second user triggers the control link through a browser or an application installed on the second terminal;
generate and transmit, in response to the access request, control link information comprising data for display the control panel, wherein the control panel is embedded within a web interface independent of the social platform;
establish, a real-time socket connection between the first terminal and the second terminal via a socket server, the socket connection configured to transmit operational input data from the control panel in real-time.

3. The system of claim 2, further causing the system to:
upon receiving the access request from the second terminal, verify the validity and expiration status of the control link;
when the control link is valid and unexpired, transmit a connection notification to the first terminal to prompt the first user to accept or reject a real-time connection request from the second user;
establish the real-time connection between the first terminal and the second terminal via the socket connection upon acceptance of the request by the first user, wherein the socket connection enables bidirectional transmission of the activation command and control panel interaction data.

4. The system of claim 1, further causing the system to:
receive an indication of one or more tokens from the second user's terminal device, wherein the tokens are associated with the second user's account;
verify, in response to the token indication, whether a total amount of tokens received from the second user's terminal device is greater than or equal to a preset reward parameter;
initiate the control connection establishment process when the total token amount meets or exceeds the reward parameter, wherein the reward parameter is pre-configured by the first user via the control interface and corresponds to at least one operational mode of the sexual stimulation device.

5. The system of claim 1, further causing the system to:
display status information and control keys on the control interface, wherein the status information includes a waiting status of the first user's terminal and a connection status of the second user's terminal;
receive control inputs from the first user via the control keys, the control inputs corresponding to different operation levels, patterns, or durations of the sexual stimulation device, wherein the control keys include preset operation buttons associated with the reward parameter.

6. The system of claim 1, further causing the system to:
provide a financial transaction interface via the control interface to support transfer of virtual or real currency from the second user to the first user;
upon receiving a transfer confirmation from the second user, synchronize the transfer information to both the first user's terminal and the second user's terminal, and generate a transaction credential.

7. The system of claim 1, further causing the system to:
establish local connections with multiple sexual stimulation devices through the first user's terminal, wherein the multiple devices are paired with the first user's terminal via Bluetooth or short-range wireless communication protocols;
display a list of the multiple sexual stimulation devices on the control interface, and allow the second user to select a target device via the control panel to transmit the activation command.

8. The system of claim 1, further causing the system to:
verify the validity and non-expired status of the control link when the second user accesses the control link;
when the control link is valid and unexpired, send a connection request notification to the first user's terminal, the notification including the second user's identity identifier or permission level;
determine whether to establish the real-time connection based on the first user's acceptance or rejection of the connection request.

9. The system of claim 1, further causing the system to:
set a valid time for each control link, the valid time being configured by the first user at the time of control link generation;
automatically terminate the real-time connection and the local connection, and disable access to the control link, upon expiration of the valid time;
respond to a manual operation by the first user to terminate the validity of the control link in advance.

10. The system of claim 1, further causing the system to:
establish a bidirectional communication channel via the real-time connection to support transmission of text, audio, or video data between the first user's terminal and the second user's terminal.

11. An interactive online entertainment method, comprising:
establishing, by a system, a local connection between a first terminal of a first user and a sexual stimulation device of the first user through an application installed on the first terminal of the first user, wherein the first user is a viewer;
receiving, by a system, a control link generation request from a first terminal of a first user, the request being transmitted via the application or a browser installed on the first terminal of the first user;
generating, by a system, a control link in response to the request, the control link comprising a uniform resource locator configured to instantiate a control interface independent of a social platform;
transmitting, by a system, the control link to the first terminal;
transmitting, by a system, the control link from the first terminal of the first user to a second terminal of a second user when the first user posts the control link to the second user as a private message on a social platform, wherein the second user is a host of a live-stream platform;
establishing, by a system, a real-time connection between the first terminal of the first user and a second terminal of the second user when the second user access the control link from the second terminal;
providing, by a system, to the second terminal in response to access of the control link, the control interface configured to display a control panel independent of the social platform, wherein the control panel is adapted to receive operational input from the second user;
receiving, by a system, from the second terminal, an activation command generated based on the operational input received by the control panel;
relaying, by a system, the activation command from the second terminal to the first terminal;
enabling, by a system, the first terminal to transmit the activation command to the sexual stimulation device via the established local connection, thereby activating the sexual stimulation device to perform an operational mode corresponding to the activation command.

12. The method of claim 11, further causing the system to:
receive, via an HTTP server, an access request from the second terminal when the second user triggers the control link through a browser or an application installed on the second terminal;
generate and transmit, in response to the access request, control link information comprising data for rendering the control panel, wherein the control panel is embedded within a web interface independent of the social platform;
establish a real-time socket connection between the first terminal and the second terminal via a socket server, the socket connection configured to transmit operational input data from the control panel in real-time.

13. The method of claim 12, further causing the system to:
upon receiving the access request from the second terminal, verify, by a system, the validity and expiration status of the control link;
when the control link is valid and unexpired, transmit, by a system, a connection notification to the first terminal to prompt the first user to accept or reject a real-time connection request from the second user;
establish, by a system, the real-time connection between the first terminal and the second terminal via the socket connection upon acceptance of the request by the first user, wherein the socket connection enables bidirectional transmission of the activation command and control panel interaction data.

14. The method of claim 11, further causing the system to:
receive, by a system, an indication of one or more tokens from the second user's terminal device, wherein the tokens are associated with the second user's account;
verify, in response to the token indication, whether a total amount of tokens received from the second user's terminal device is greater than or equal to a preset reward parameter;
initiate, by a system, the control connection establishment process when the total token amount meets or exceeds the reward parameter, wherein the reward parameter is pre-configured by the first user via the control interface and corresponds to at least one operational mode of the sexual stimulation device.

15. The method of claim 11, further causing the system to:
display, by a system, status information and control keys on the control interface, wherein the status information includes a waiting status of the first user's terminal and a connection status of the second user's terminal;
receive, by a system, control inputs from the first user via the control keys, the control inputs corresponding to different operation levels, patterns, or durations of the sexual stimulation device, wherein the control keys include preset operation buttons associated with the reward parameter.

16. The method of claim 11, further causing the system to:
provide, by a system, a financial transaction interface via the control interface to support transfer of virtual or real currency from the second user to the first user;
upon receiving a transfer confirmation from the second user, synchronize, by a system, the transfer information to both the first user's terminal and the second user's terminal, and generate a transaction credential.

17. The method of claim 11, further causing the system to:
establish, by a system, local connections with multiple sexual stimulation devices through the first user's terminal, wherein the multiple devices are paired with the first user's terminal via Bluetooth or short-range wireless communication protocols;
display, by a system, a list of the multiple sexual stimulation devices on the control interface, and allow the second user to select a target device via the control panel to transmit the activation command.

18. The method of claim 11, further causing the system to:
verify, by a system, the validity and non-expired status of the control link when the second user accesses the control link;
when the control link is valid and unexpired, send, by a system, a connection request notification to the first user's terminal, the notification including the second user's identity identifier or permission level;
determine whether to establish the real-time connection based on the first user's acceptance or rejection of the connection request.

19. The method of claim 11, further causing the system to:
set, by a system, a valid time for each control link, the valid time being configured by the first user at the time of control link generation;
automatically terminate, by a system, the real-time connection and the local connection, and disable access to the control link, upon expiration of the valid time;
respond to a manual operation by the first user to terminate the validity of the control link in advance.

20. A non-transitory computer-readable storage medium comprising computer-executable instructions that, when executed by at least a processor of an application server, cause the application server to perform a method comprising:
establishing a local connection between a first terminal of a first user and a sexual stimulation device of the first user through an application installed on the first terminal of the first user, wherein the first user is a viewer;
receiving a control link generation request from a first terminal of a first user, the request being transmitted via the application or a browser installed on the first terminal of the first user;
generating a control link in response to the request, the control link comprising a uniform resource locator configured to instantiate a control interface independent of a social platform;
transmitting the control link to the first terminal;
transmitting the control link from the first terminal of the first user to a second terminal of a second user when the first user posts the control link to the second user as a private message on a social platform, wherein the second user is a host of a live-stream platform;
establishing a real-time connection between the first terminal of the first user and a second terminal of the second user when the second user access the control link from the second terminal;
providing to the second terminal in response to access of the control link, the control interface configured to display a control panel independent of the social platform, wherein the control panel is adapted to receive operational input from the second user;
receiving from the second terminal, an activation command generated based on the operational input received by the control panel;
relaying the activation command from the second terminal to the first terminal;
enabling the first terminal to transmit the activation command to the sexual stimulation device via the established local connection, thereby activating the sexual stimulation device to perform an operational mode corresponding to the activation command.
